(19) United States
(12) Patent Application Publication
(10) Pub. No.: US 2025/0304333 A1
(43) Pub. Date: Oct. 2, 2025

(54) ENCLOSURE WITH REMOVABLE LID AND METHOD OF FORMATION THEREOF

(71) Applicants: Brandon Foon, Rosemead, CA (US); Edward Tang, Rosemead, CA (US)

(72) Inventors: Brandon Foon, Rosemead, CA (US); Edward Tang, Rosemead, CA (US)

(21) Appl. No.: 18/623,329

(22) Filed: Apr. 1, 2024

(51) Int. Cl. A01K 63/00; B65D 43/02; B65D 51/16; B65D 85/52

(52) U.S. Cl. CPC B65D 43/0214; A01K 63/003; B65D 51/1611; B65D 85/52; B65D 2543/00564

(57) ABSTRACT

An enclosure apparatus includes a base in a substantially horizontal orientation, the base includes a base perimeter that is located at the edges of the base. The enclosure includes at least three walls comprising geometric dimensions substantially corresponding to the geometric dimensions of the base when the at least three walls are attached to one another. The enclosure includes a bottom rim located at the lower-vertical side of the at least three walls. The enclosure includes a top rim of the at least three walls. The top rim includes an upper point and a lower point. The enclosure includes a lid comprising geometric dimensions substantially corresponding to the geometric dimensions of the base and the at least three walls. The enclosure includes a perimeter of the lid comprising an outer point of the perimeter and an inner point of the perimeter.

### FIELD OF TECHNOLOGY

An enclosure with a removable lid and associated methods of formation are described, and more particularly to an enclosure apparatus in the form of an aquarium, terrarium, and paludarium, and its associated methods of formation.

### BACKGROUND

An enclosure may be used commercially to grow and/or showcase plants and/or animals for hobbyists, educational institutions, research purposes, decorative purposes, and/or conservation purposes. The enclosure may be used by home hobbyists, gardening enthusiasts, and/or educational institutions to form microenvironments to foster plant growth despite an incompatible ambient environment. In addition, the enclosure may be used to add visual beauty and/or interior design to one's home, business, and/or office. Furthermore, the enclosure may be used commercially to breed and grow animals, plants, fungi, protists, and/or monera.

The enclosure may be bulky and/or require an overly large footprint because the enclosure may require hinged openings with a door that moves in a pivoting manner. The hinged openings may require the enclosure to be placed in a limited number of spatial settings due to a need for enough space to allow movement of the door and/or hinged opening. The hinged opening may also comprise metal hardware which can oxidate and deteriorate due to the presence of water. Oxidation may eventually cause the metal hardware to fail, creating a need for replacement.

The enclosure may have an opening with a cover that is attached to the enclosure via clips and/or brackets. These clips and/or brackets may not properly lock the cover to the enclosure, which may result in environmental and/or safety issues for users, animals, plants, and/or other items within the enclosure. If the opening does not properly close, animals may escape from the enclosure, which can cause harm to both the animal, humans, and/or other animals. If the door of the opening improperly closes, the environment within the enclosure may be disrupted (e.g. change of temperature, humidity, pressure, cleanliness, etc.), which may harm plants and/or animals within the enclosure.

Furthermore, like metal hardware of a hinged opening, the clips and brackets may deteriorate and/or oxidize when contacted with water and salt water. This deterioration may cause a system failure, further exacerbating existing safety issues.

### SUMMARY

Disclosed is an enclosure with a removable lid and associated methods of formation. Other features will be apparent from the accompanying drawings and from the detailed description that follows.

In one aspect, an enclosure includes a base in a substantially horizontal orientation, the base comprising a base perimeter that is located at the edges of the base. The base comprises geometric dimensions comprising at least three sides. The enclosure includes at least three walls comprising geometric dimensions substantially corresponding to the geometric dimensions of the base when the at least three walls are attached to one another. The at least three walls are attached at a plurality of forming edges. The plurality of forming edges are mitered into the vertical sides of the at least three walls and form a total of at least one hundred and eighty degrees when the at least three walls are joined together.

The enclosure further includes a bottom rim located at the lower-vertical side of the at least three walls. The base perimeter of the base is connected to the at least three walls at an area adjacent to the bottom rim of the at least three walls. The enclosure further includes a top rim of the at least three walls comprising an upper point and a lower point. The upper point is adjacent to an outside face of the at least three walls and the lower point is adjacent to an inside face of the at least three walls. The upper point and the lower point of the top rim are configured to form an oblique angle relative to each other.

The enclosure further includes a lid comprising geometric dimensions substantially corresponding to the geometric dimensions of the base and the at least three walls. The enclosure further includes a perimeter of the lid comprising an outer point of the perimeter and an inner point of the perimeter. The outer point is at an upside of the lid and the inner point is at an underside of the lid, and the outer point and the inner point of the perimeter are configured to form an oblique angle relative to each other.

The enclosure may further include wherein the upper point and/or the lower point of the top rim are positioned at a forty-five degree angle from one another. The enclosure may further include wherein the outer point and/or the inner point of the perimeter of the lid are positioned at a forty-five degree angle from one another.

The enclosure may further include wherein the top rim of the at least three walls and/or the perimeter of the lid form a ninety-degree angle when the lid is placed on the top rim of the at least three walls. The enclosure may further include wherein the outer point and/or the upper point are adjacent to one another when the lid is placed on the top rim of the at least three walls. The enclosure may further include wherein the inner point and/or the lower point are adjacent to one another when the lid is placed on the top rim of the at least three walls.

The enclosure may further include a lid spacer removably attached to the perimeter of the lid. The lid spacer may separate the lid from at least one wall of the at least three walls to facilitate humidity control and/or air movement into and/or out of the enclosure. The enclosure may further include a rim spacer removably attached to the top rim of at least one wall of the at least three walls.

The rim spacer may separate the lid from at least one wall of the at least three walls to facilitate humidity control and/or air movement into and/or out of the enclosure. The lid spacer may comprise a body having a shape at least partially complementary to the perimeter of the lid. The complementary shape of the lid spacer may allow the lid spacer to removably attach to the perimeter of the lid.

The enclosure may further include wherein the rim spacer may comprise a body having a shape at least partially complementary to the top rim of the at least three walls. The complementary shape of the rim spacer may allow the rim spacer to removably attach to the top rim of at least one wall of the at least three walls. The enclosure may further include wherein the at least three walls, the base, and/or the lid are made of a transparent material, allowing for clear visibility into the interior of the enclosure. The transparent material may be at least one of a glass, an acrylic, a polycarbonate, a tempered glass, a reinforced safety glass, a plexiglass, a laminated glass, a borosilicate glass, and/or a clear resin material.

The enclosure may further include a ventilation opening cut into the lid allowing for air exchange from the enclosure into the exterior environment while maintaining the structural integrity and/or moisture levels suitable for the habitat within the enclosure. The enclosure may further include wherein the forming edges where the at least three walls meet are sealed with a water-tight material, which may make the enclosure suitable for use as an aquarium. The water-tight material may be at least one of a silicone sealant, an epoxy resin, a polyurethane sealant, a rubber gasket material, a marine-grade adhesive, a butyl rubber sealant, a TPE (thermoplastic elastomer) sealant, a polysulfide sealant, an acrylic sealant, and/or a PVC (polyvinyl chloride) sealant.

In another aspect, an enclosure comprises four walls and a base. The base comprises geometric dimensions of at least one of a square, a rectangle, a rhombus, a parallelogram, a trapezoid, and a kite. The four walls are connected to each other at a plurality of forming edges to form the substantially same geometric shape of the base. The plurality of forming edges are mitered into the vertical sides of the four walls and form a shape comprising a total of at least three-hundred and sixty degrees when the four walls are joined together to form the enclosure.

The enclosure further includes a base perimeter located at the outer portion of the base. The enclosure further includes a bottom rim of the four walls located at the lower-horizontal portion of each of the four walls. The bottom rim of the four walls are connected to the base perimeter of the base. The base perimeter of the base is connected to the four walls at an area adjacent to the bottom rim of the four walls. Furthermore, when the four walls and the base are connected, the bottom rim is exterior to the base perimeter, and when connected, the bottom rim and the base perimeter form a ninety-degree angle.

The enclosure further includes a top rim of the four walls that is mitered into the upper-horizontal side of each of the four walls at a forty-five degree angle. The top rim comprises an upper point and a lower point. The upper point of the rim is at an outside face of the four walls, and the lower point is at an inside face of the four walls. The upper point and the lower point are positioned forty-five-degrees from one another.

The enclosure further includes a lid comprising geometric dimensions substantially corresponding to the geometric dimensions of the base and the four walls. The lid is placed on the enclosure to substantially seal the enclosure from the outside environment. The enclosure further includes a perimeter of the lid comprising an outer point and an inner point. The perimeter of the lid is at the outermost portion of the lid. The outer point is positioned at an upside of the lid and the inner point is at an underside of the lid. The outer point and inner point are positioned forty-five-degrees from each other. When the lid is placed on the top rim of the four walls of the enclosure, the outer point and upper point are adjacent to one another, and the inner point and lower point are adjacent to one another. Furthermore, the top rim of the four walls and the perimeter of the lid form a ninety degree angle when the lid is placed on the top rim of the at least four walls.

The enclosure further includes a spacer removably attached to at least one of the perimeter of the lid and the top rim of at least one wall of the four walls of the enclosure. The spacer separates the lid from the enclosure and accommodates airflow into the enclosure to maintain consistent humidity and temperature. The spacer comprises a body having a shape at least partially complementary to at least one of the perimeter of the lid and the top rim of at least one wall of the four walls of the enclosure. The enclosure further includes a ventilation opening cut into the lid to allow for air exchange between the enclosure and the area outside of the enclosure while maintaining moisture levels suitable for the habitat within the enclosure.

The enclosure may further include wherein when the four walls are connected at the forming edges, the two corresponding adjacent forming edges create at least a ninety-degree angle when connected to each other. The enclosure may further include wherein the ventilation opening is circular and/or is positioned substantially at the center of the lid.

The enclosure may further include wherein the four walls, the base, and/or the lid are made of at least one of a glass, an acrylic, a polycarbonate, a tempered glass, a reinforced safety glass, a plexiglass, laminated glass, a borosilicate glass, and/or a clear resin materials, which may allow for visibility into the interior of the enclosure and/or through the enclosure. The enclosure may further include wherein the four walls and/or the base are sealed to each other with a water-tight material, making the apparatus suitable for use as an aquarium.

In yet another aspect, a method of manufacturing an apparatus comprises forming a base comprising geometric dimensions of at least one of a square, a rectangle, a rhombus, a parallelogram, a trapezoid, and a kite. The method cuts a base perimeter into the outer portion of the base. The method then connects four walls to each other at a plurality of forming edges. The plurality of forming edges are mitered at a forty-five-degree angle and form a ninety-degree angle when joined to one another. The method cuts a bottom rim of the four walls into the lower-horizontal portion of each of the four walls.

The method then attaches the four walls and the base by attaching the bottom rim of the four walls to the base perimeter to form an enclosure. When the four walls are attached to the base, the bottom rim of the four walls is exterior to the base perimeter of the base. The four walls adopt geometric dimensions substantially corresponding to the geometric shape of the base when the four walls are joined together at the forming edges. The method then defines a top rim of the four walls that is mitered into the upper-horizontal side of each of the four walls at a forty-five degree angle. The top rim comprises an upper point and a lower point.

The upper point of the rim is at an outside face of the four walls, and the lower point is at an inside face of the four walls. The upper point and the lower point are positioned forty-five-degrees from one another. The method fabricates a lid comprising geometric dimensions substantially corresponding to the geometric dimensions of the base and the four walls. The method miters a perimeter of the lid comprising an outer point and an inner point. The outer point is positioned at an upside of the lid and the inner point is at an underside of the lid. The outer point and inner point are positioned forty-five-degrees from each other.

The method may attach a spacer to at least one of the perimeter of the lid and/or the top rim of at least one wall of the four walls of the enclosure. The spacer may at least partially separate the lid from the enclosure and/or accommodate airflow into the enclosure to maintain consistent humidity and/or temperature. The spacer may comprise a body having a shape at least partially complementary to at least one of the perimeter of the lid and/or the top rim of at least one wall of the four walls of the enclosure.

The method may cut a ventilation opening into the lid to allow for air exchange between the enclosure and/or the area outside of the enclosure while maintaining moisture levels suitable for the habitat within the enclosure. The method may select a material for constructing the base, the four walls, and/or the lid. The material may be at least one of a glass, an acrylic, a polycarbonate, a tempered glass, a reinforced safety glass, a plexiglass, a laminated glass, a borosilicate glass, and/or a clear resin material.

The method may seal the plurality of forming edges of the four walls and the base with a water-tight material which may make the apparatus suitable for use as an aquarium. The water-tight material may be at least one of a silicone sealant, an epoxy resin, a polyurethane sealant, a rubber gasket material, a marine-grade adhesive, a butyl rubber sealant, a TPE (thermoplastic elastomer) sealant, a polysulfide sealant, an acrylic sealant, and/or a PVC (polyvinyl chloride) sealant. The method may then miter the perimeter of the lid at a forty-five-degree angle.

The method may assemble the base, the four walls, and/or the lid as the enclosure. The method may then ensure that the geometric shape of the base perimeter of the base, the enclosure, and/or the perimeter of the lid correspond to each other. The method may attach a spacer to at least one of the perimeter of the lid and/or the top rim of at least one wall of the enclosure. The method may cut a ventilation opening into the center of the lid. Furthermore, the method may ensure that the top rim of the enclosure and/or the perimeter of the lid form a snug fit due to the forty-five-degree mitered forming edges, which may create a self-locking, friction-fit connection that secures the lid to the enclosure.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of the enclosure with the lid placed on the enclosure, according to one embodiment.

FIG. 2 is an exploded view of the enclosure of FIG. 1 wherein the plurality of walls, the base, and the lid are shown apart from one another, according to one embodiment.

FIG. 3 is a schematic illustration of the enclosure of FIGS. 1 & 2 wherein the lid is removed from the enclosure, according to one embodiment.

FIG. 4 is a schematic illustration of the enclosure of FIGS. 1-3 wherein a plurality of lid spacers are attached to the lid, according to one embodiment.

FIG. 5 is a schematic illustration of the enclosure of FIGS. 1-4 wherein a plurality of rim spacers are attached to the top rim of the enclosure, according to one embodiment.

FIG. 6 is an alternative embodiment of the enclosure of FIGS. 1-5 wherein the enclosure is in a triangular shape, according to one embodiment.

FIG. 7 is an exploded view of the enclosure of FIG. 6 wherein the walls, the base, and the lid are shown apart from one another, according to one embodiment.

FIG. 8 is a schematic illustration of the enclosure of FIGS. 6 & 7 wherein the lid is removed from the enclosure, according to one embodiment.

FIG. 9 is a schematic illustration of the enclosure of FIGS. 6-8 wherein a plurality of lid spacers are attached to the lid, according to one embodiment.

FIG. 10 is a schematic illustration of the enclosure of FIGS. 6-9 wherein a plurality of rim spacers are attached to the top rim of the enclosure, according to one embodiment.

FIGS. 11A & 11B are process flow diagrams showing the steps of forming the various enclosure embodiments of FIGS. 1-10, according to one embodiment.

Other features of the present embodiments will be apparent from the accompanying drawings and from the detailed description that follows.

### DETAILED DESCRIPTION

Enclosures with removable lids and associated methods of construction are described, and more particularly to an enclosure in the form of an aquarium, a terrarium, and/or a paludarium, and its associated methods of construction.

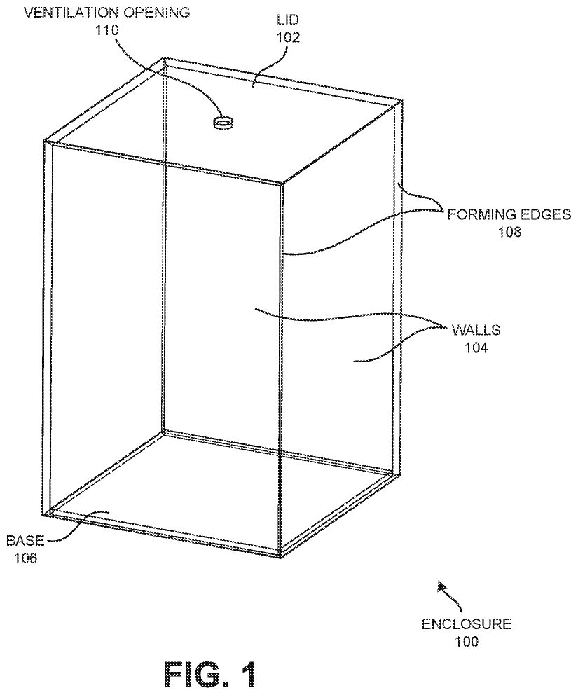

FIG. 1 is a schematic view of the enclosure 100 with the lid 102 placed on the enclosure 100, according to one embodiment. FIG. 1 discloses an enclosure 100, a lid 102, a plurality of walls 104, a base 106, a plurality of forming edges 108, and/or a ventilation opening 110. The enclosure 100 may comprise the base 106, the plurality of walls 104, and/or the lid 102. The lid may be made of a transparent material. The lid 102 may enclose the interior space of the enclosure 100 securely which may allow the enclosure 100 to be used as a terrarium, an aquarium, and/or a paludarium. The lid 102 may be a removable roof-like structure crafted for easy placement and/or removal while maintaining a secure fit on the enclosure 100. The lid 102 may incorporate features for light installation and/or ventilation.

The plurality of walls 104 may be any number of walls and may form any geometric configuration. The plurality of walls 104 may be constructed from transparent material for clear viewing and may comprise mitered edges which may ensure a seamless appearance. The plurality of walls 104 may comprise the forming edges 108, a top rim 202 (not shown), and/or a bottom rim 204 (not shown). The plurality of walls 104 may be of any shape and may be taller than they are wide.

The base 106 may be the bottom portion of the enclosure 100 and may be reinforced for stability and/or water resistance. The base 106 may be any geometric configuration and may be formed of a transparent material. The base 106 may be configured to sit on a flat and/or substantially flat surface. The base 106 may comprise a base perimeter 212 (not shown) which may be connected to the corresponding bottom rim 204 (not shown) of the plurality of walls 104. The plurality of forming edges 108 may be formed and/or mitered into the vertical edges of the plurality of walls 104. The plurality of forming edges 108 may be angled to connect the plurality of walls 104 and/or enhance the structural integrity of the enclosure 100. The ventilation opening 110 may be a strategically placed opening anywhere in the lid 102 that may promote air circulation without compromising humidity control and/or animal escape prevention. The ventilation opening 110 may be any shape and/or any size.

According to one embodiment, FIG. 1 discloses an enclosure 100 that may comprise four walls 104 (the plurality of walls 104) and/or the base 106. The base 106 may comprise geometric dimensions of at least one of a square, a rectangle, a rhombus, a parallelogram, a trapezoid, and/or a kite. The four walls 104 may be connected to each other at a plurality of forming edges 108 and/or may form the substantially same geometric shape of the base 106. The forming edges 108 may be the vertical sides of the walls 104 and may be configured to connect to each other (e.g. at a corresponding forming edge 108).

When the four walls 104 are connected at each of the forming edges 108, the four walls 104 may form a shape comprising a total of at least three-hundred and sixty degrees. Furthermore, when the four walls 104 are connected at the forming edges 108, the two corresponding adjacent forming edges 108 that connect to each other may create at least a ninety-degree angle when connected to each other. Furthermore, The four walls 104 and/or the base 106 may be sealed to each other with a water-tight material which may make the apparatus suitable for use as an aquarium.

The enclosure may further comprise a lid 102 that may comprise geometric dimensions substantially corresponding to the geometric dimensions of the base 106 and/or the four walls 104 as to allow the lid 102 to sit on top of the enclosure 100 formed from the base 106 and the four walls 104 without risk of the lid 102 falling off of the enclosure 100. The lid 102 may be placed on the enclosure 100 to substantially seal the enclosure 100 from the outside environment. A ventilation opening 110 may be cut into the lid 102 which may allow for air exchange between the enclosure 100 and the area outside of the enclosure 100 while maintaining moisture levels suitable for the habitat within the enclosure 100. The ventilation opening 110 may be circular and may be positioned substantially at the center of the lid 102.

Furthermore, the four walls 104, the base 106, and the lid 102 may be made of at least one of a glass, an acrylic, a polycarbonate, a tempered glass, a reinforced safety glass, a plexiglass, laminated glass, a borosilicate glass, and a clear resin materials, allowing for visibility into the interior of the enclosure 100 and through the enclosure 100.

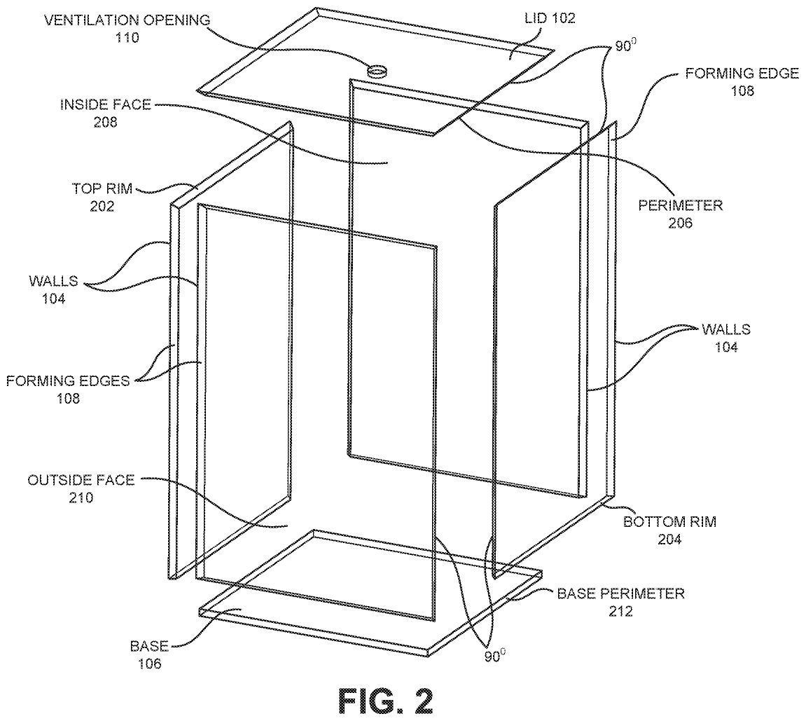

FIG. 2 is an exploded view of the enclosure 100 of FIG. 1 wherein the plurality of walls 104, the base 106, and the lid 102 are shown apart from one another, according to one embodiment. FIG. 2 comprises the lid 102, the plurality walls 104, the base 106, the plurality of forming edges 108, the ventilation opening 110, a top rim 202, a bottom rim 204, a perimeter 206, an inside face 208, an outside face 210, and/or a base perimeter 212. The top rim 202 may be the upper horizontal edges of the plurality of walls 104 which may be mitered and/or formed into the plurality of walls 104 at an angle that forms a ninety-degree angle when placed adjacent to the perimeter 206 of the lid 102, which may enhance structural stability and/or provide a clean line that visually frames the enclosure 100. The top rim 202 may be formed and/or mitered at any angle.

The bottom rim 204 may be the bottom horizontal edges of the plurality of walls 104 which may be mitered and/or formed at an angle that forms a ninety-degree angle when placed adjacent to the base perimeter 212. The bottom rim 204 may attach to the base 106 at the base perimeter 212 which may fortify the enclosure's 100 foundation. The bottom rim 204 may be formed and/or mitered at any angle. The base perimeter 212 of the base 106 may be connected to the walls 104 at an area adjacent to the bottom rim 204 of the walls 104. When connected to the base perimeter 212 of the base 106, the bottom rim 204 may be exterior to the base perimeter 212. The perimeter 206 may be the outer edges of the lid 102 and/or may be mitered and/or formed at an angle that forms a ninety-degree angle when placed adjacent to the top rim 202 of the plurality of walls 104.

The inside face 208 may be the inner surface of the walls 104 and may be optimized for the well-being of the enclosure's 100 contents. The outside face 210 may be the exterior surface of the walls and may be treated for resilience and/or aesthetic quality. The base perimeter 212 may be the edges of the base 106 and may form an angle that creates a ninety-degree angle when adjacent to the bottom rim 204 of the plurality of walls 104 which may ensure a water-tight seal and/or a visually appealing finish. The base perimeter 212 may be cut into the base at any angle. The base perimeter 212 of the base 106 may connect to the walls at the inside face 208 portion of the bottom rim 204.

According to one embodiment, FIG. 2 discloses the enclosure 100 which may comprise a base perimeter 212 cut into the outer portion of the base 106. A bottom rim 204 of the four walls 104 (e.g. the plurality of walls 104) may be at the lower-horizontal portion of each of the four walls 104. The bottom rim 204 of the four walls 104 may be connected to the base perimeter 212 of the base 106. When connected, the bottom rim 204 and the base perimeter 212 may form a ninety-degree angle. A top rim 202 of the four walls 104 may be mitered into the upper-horizontal side of each of the four walls 104 at a forty-five degree angle.

A perimeter 206 may be cut into the outermost edges of the lid 102 and the perimeter 206 of the lid 102 may be the outermost portion of the lid 102. The top rim 202 of the four walls 104 and the perimeter 206 of the lid 102 may form a ninety-degree angle when the lid 102 is placed on the top rim 202 of the at least four walls 104. Furthermore, when the four walls 104 are connected at the forming edges 108, the two corresponding adjacent forming edges 108 may create at least a ninety-degree angle when connected to each other.

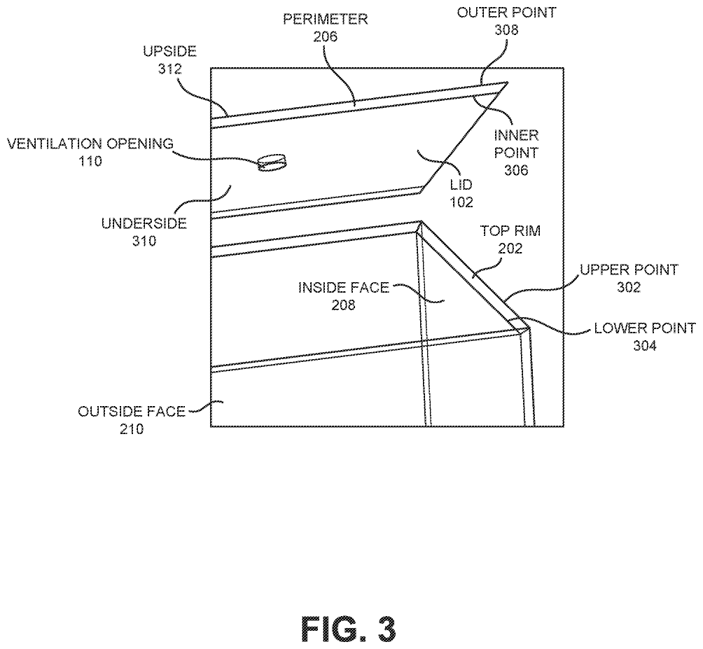

FIG. 3 is a schematic illustration of the enclosure 100 of FIGS. 1 & 2 wherein the lid 102 is removed from the enclosure 100, according to one embodiment. FIG. 3 comprises the ventilation opening 110, the top rim 202, the perimeter 206, the inside face 208, the outside face 210, an upper point 302, a lower point 304, an inner point 306, an outer point 308, an underside 310, and an upside 312. The upper point 302 may be positioned at the outermost portion of the top rim 202 of the plurality of walls 104 of the enclosure 100 which may correspond to the highest point when viewed from the outside of the enclosure 100. The upper point 302 may serve as a reference for aligning the lid 102 during assembly and may ensure a proper fit. The lower point 304 may be situated at the innermost portion of the top rim 202 of the plurality of walls 104 of the enclosure 100.

The lower point 304 may be obliquely adjacent to the upper point 302 and/or may assist in aligning the lid 102 when placing the lid on the top rim 202 of the plurality of walls 104. The inner point 306 may be located at the underside 310 of the lid 102 perimeter 204 and/or may serve as a reference point for attaching the lid spacer 402 (not shown). The inner point 306 may ensure proper alignment of the lid spacer 402 (not shown) to maintain consistent airflow into the enclosure while preventing excess moisture buildup. The outer point 308 may be positioned at the upside of the lid 102 perimeter 204 and may serve as a reference point for attaching the lid spacer 402 (not shown).

The outer point 308 may aid in aligning the lid spacer 402 (not shown) to facilitate airflow into the enclosure 100 while maintaining a secure seal between the lid 102 and the plurality of walls 104 of the enclosure 100. The underside 310 may be the inner surface of the lid 102, facing towards the interior of the enclosure 100 when the lid 102 is in place. The underside 310 may feature attachment points for the lid spacer 402 (not shown) and the ventilation opening 110 to allow for air exchange while maintaining suitable habitat conditions. The upside 312 may be the outer-upper surface of the lid 102 which may face away from the enclosure 100 when the lid 100 is in place. The upside 312 may include features including but not limited to the outer point 308 of the lid 102 perimeter 204 and/or at least a portion of the ventilation opening 100 which may enable airflow regulation and moisture control within the enclosure 100.

According to one embodiment, FIG. 3 discloses the enclosure 100 which may comprise the top rim 202 further comprising the upper point 302 and/or the lower point 304. The upper point 302 of the top rim 202 may be at the outside face 210 of the four walls 104 (the plurality of walls 104), and the lower point 304 may be at the inside face 208 of the four walls 104. The upper point 302 and the lower point 304 may be positioned forty-five degrees from one another;

The perimeter 206 of the lid 102 may further comprise the outer point 308 and/or the inner point 306. The outer point 308 may be positioned at the upside 312 of the lid 102 and/or the inner point 306 may be at the underside 310 of the lid 102. The outer point 308 and inner point 306 may be positioned forty-five degrees from each other. When the lid 102 is placed on the top rim 202 of the four walls 104 of the enclosure 100, the outer point 308 and upper point 302 may be adjacent to one another, and the inner point 306 and lower point 304 may be adjacent to one another.

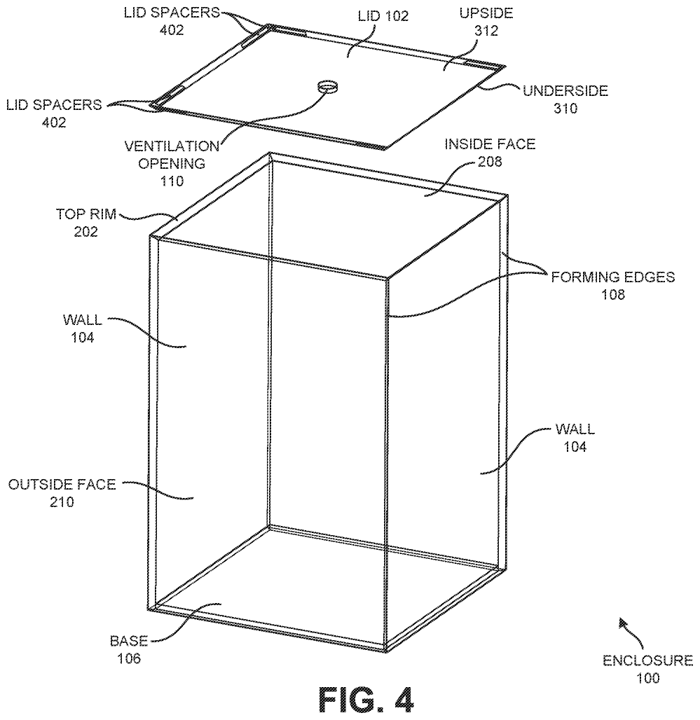

FIG. 4 is a schematic illustration of the enclosure 100 of FIGS. 1-3 wherein a plurality of lid spacers 402 are attached to the lid 102, according to one embodiment. FIG. 4 comprises the lid 102, the plurality walls 104, the base 106, the plurality of forming edges 108, the ventilation opening 110, the top rim 202, the bottom rim 204, the inside face 208, the outside face 210, the underside 310, the upside 312, and/or a lid spacer 402. The lid spacer 402 may be a removable component attached to the perimeter 206 of the lid 102. The lid spacer 402 may create a gap between the lid 102 and at least one wall 104 of the enclosure 100. This gap may facilitate airflow into the enclosure 100. The lid spacer 402 may aid in humidity control and temperature regulation while ensuring the structural integrity of the enclosure 100.

According to one embodiment, FIG. 4 discloses the enclosure 100 comprising the lid spacer 402 that may be removably attached to at least one of the perimeter 206 of the lid 102 and/or the top rim 202 of at least one wall of the four walls 104 (the plurality of walls 104) of the enclosure 100. The lid spacer 402 may separate the lid 102 from the enclosure 100 and may accommodate airflow into the enclosure 100 to maintain consistent humidity and temperature. The lid spacer 402 may further comprise a body that may have a shape at least partially complementary to at least one of the perimeter 206 of the lid 102 and/or the top rim 202 of at least one wall of the four walls 104 of the enclosure 100.

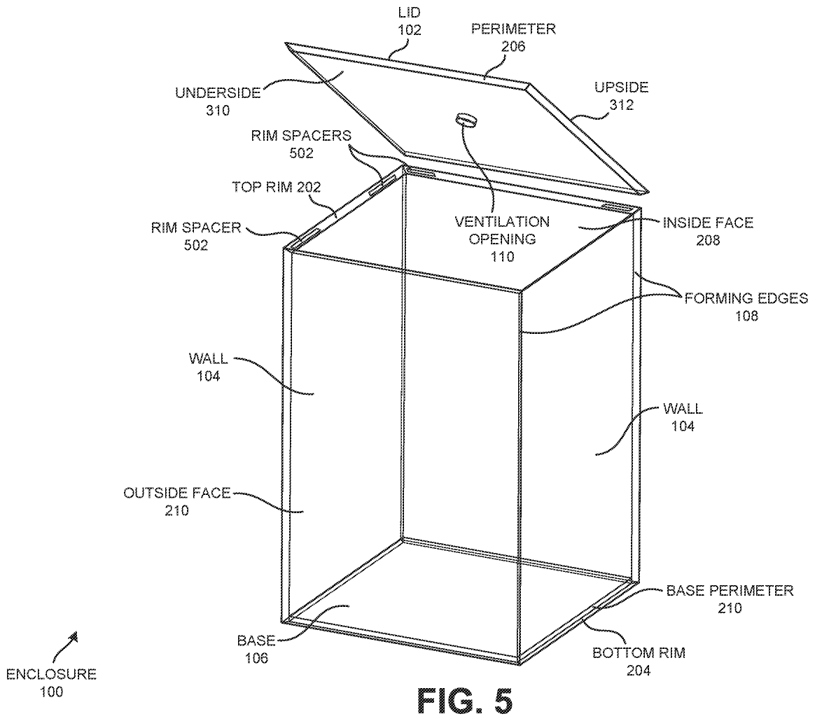

FIG. 5 is a schematic illustration of the enclosure 100 of FIGS. 1-4 wherein a plurality of rim spacers 502 are attached to the top rim 202 of the enclosure 100, according to one embodiment. FIG. 5 comprises the lid 102, the plurality walls 104, the base 106, the plurality of forming edges 108, the ventilation opening 110, the top rim 202, the bottom rim 204, the inside face 208, the outside face 210, the underside 310, the upside 312, and/or a rim spacer 502. The rim spacer 502 may be a removable component attached to the top rim 202 of at least one wall 104 of the enclosure 100. The rim spacer 502 may create a gap between the lid 102 and the enclosure 100, promoting airflow and facilitating consistent humidity and temperature levels within the enclosure 100.

According to one embodiment, FIG. 5 the enclosure 100 comprises the rim spacer 502 which may be removably attached to at least one of the perimeter 206 of the lid 102 and/or the top rim 202 of at least one wall of the four walls 104 (the plurality of walls 104) of the enclosure 100. The rim spacer 502 may separate the lid 102 from the enclosure 100 and may accommodate airflow into the enclosure 100 to maintain consistent humidity and temperature. The rim spacer 502 may further comprise a body that may have a shape at least partially complementary to at least one of the perimeter 206 of the lid 102 and/or the top rim 202 of at least one wall of the four walls 104 of the enclosure 100.

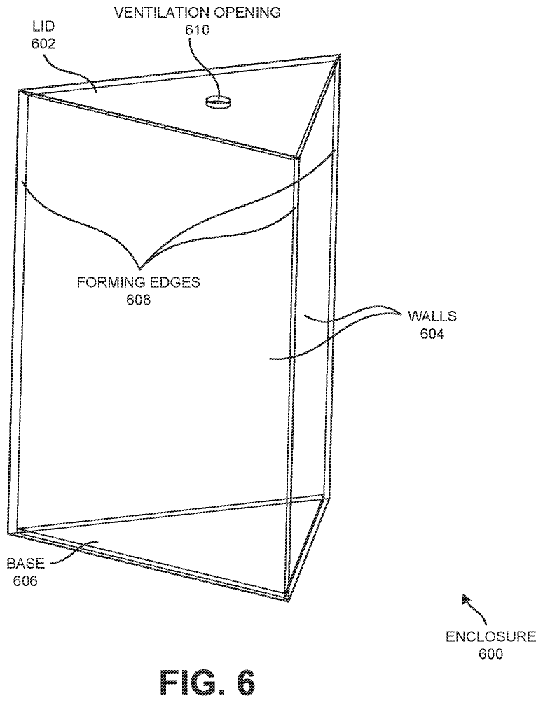

FIG. 6 is an alternative embodiment of the enclosure 600 of FIGS. 1-5 wherein the enclosure 600 is in a triangular shape, according to one embodiment. FIG. 6 discloses an enclosure 600, a lid 602, a plurality of walls 604, a base 606, a plurality of forming edges 608, and/or a ventilation opening 610. The enclosure 600 may be a containment structure designed to house and/or showcase various living organisms and/or items. The enclosure 600 may comprise a base 606, a plurality of walls 604, and/or a lid 602 which may combine to enclose the interior space securely and may be suitable for use as a terrarium, aquarium, and/or paludarium. The enclosure 600 may be formed to sit on a flat and/or semi-flat surface. The lid 602 may be a cover designed to fit over the top of the enclosure 600. The lid 602 may sit on the top rim 702 (not shown) of the enclosure 600. The lid 602 may be configured to seal the enclosure 100 and may include features including but not limited to a perimeter 706 (not shown) with oblique angles and/or a ventilation opening 610 to allow for air exchange.

The plurality of walls 604 may be vertical structures attached to the base 606 which may form the sides of the enclosure 600. The plurality of walls 604 may be the same height but may also be of differing heights. The plurality of walls 604 may be connected at forming edges 608, which may be mitered and/or formed to create precise angles and ensure a secure fit. The base 606 may be the bottom surface of the enclosure 600 and may provide support for the plurality of walls 604 and/or any contents within the enclosure 600. The base 606 may comprise varying geometric dimensions. The plurality of forming edges 608 may be the junctions where the plurality of walls 604 meet each other. This plurality of forming edges 608 may be mitered and/or formed to create specific angles to ensure a snug fit between the plurality of walls 604 while promoting structural stability. The ventilation opening 610 may be an aperture cut into the lid 602 to facilitate air exchange between the interior of the enclosure 600 and the external environment. The ventilation opening 610 may help maintain optimal humidity levels and airflow for the well-being of living organisms housed within the enclosure 600.

According to one embodiment, FIG. 6 discloses the enclosure 600 which may comprise the base 606 in a substantially horizontal orientation. The base 606 may comprise a base perimeter 712 (not shown) that may be cut and/or formed into the edges of the base 606 in an oblique orientation. The base 606 may further comprise geometric dimensions comprising at least three sides. The enclosure 600 may further comprise at least three walls (the plurality of walls) 604 that may comprise geometric dimensions substantially corresponding to the geometric dimensions of the base 606 when at least three walls 604 are attached to one another.

At least three walls 604 may be attached at the plurality of forming edges 608. The forming edges 608 may be the vertical sides of at least three walls 604. The plurality of forming edges 608 may be mitered and/or formed into the vertical sides of at least three walls 604 at an oblique angle. The at least three walls may form a total of at least one-hundred and eighty degrees when joined together at the forming edges 608. The forming edges 608, where the at least three walls 604 meet, may be sealed with a water-tight material which may make the enclosure 600 suitable for use as an aquarium. The water-tight material may be at least one of a silicone sealant, an epoxy resin, a polyurethane sealant, a rubber gasket material, a marine-grade adhesive, a butyl rubber sealant, a TPE (thermoplastic elastomer) sealant, a polysulfide sealant, an acrylic sealant, and a PVC (polyvinyl chloride) sealant.

The enclosure 600 may further comprise the lid 602 which may comprise geometric dimensions substantially corresponding to the geometric dimensions of the base 606 and/or at least three walls 604. The lid 602 may sit on at least three walls 604 to substantially close the enclosure 600 off from the outside environment. The lid may comprise the ventilation opening 610 that may be cut into the lid 602 and may allow for air exchange from the enclosure 600 into the exterior environment while maintaining the structural integrity and/or moisture levels suitable for the habitat within the enclosure 600.

The at least three walls 604, the base 606, and/or the lid 602 may be made of a transparent material that may allow for clear visibility into the interior of the enclosure 600. This transparent material may be strong enough to resist compression forces, forces from animals, hydraulic forces, and/or other forces that may cause other materials to fail. The transparent material may be at least one of a glass, an acrylic, a polycarbonate, a tempered glass, a reinforced safety glass, a plexiglass, a laminated glass, a borosilicate glass, and a clear resin material.

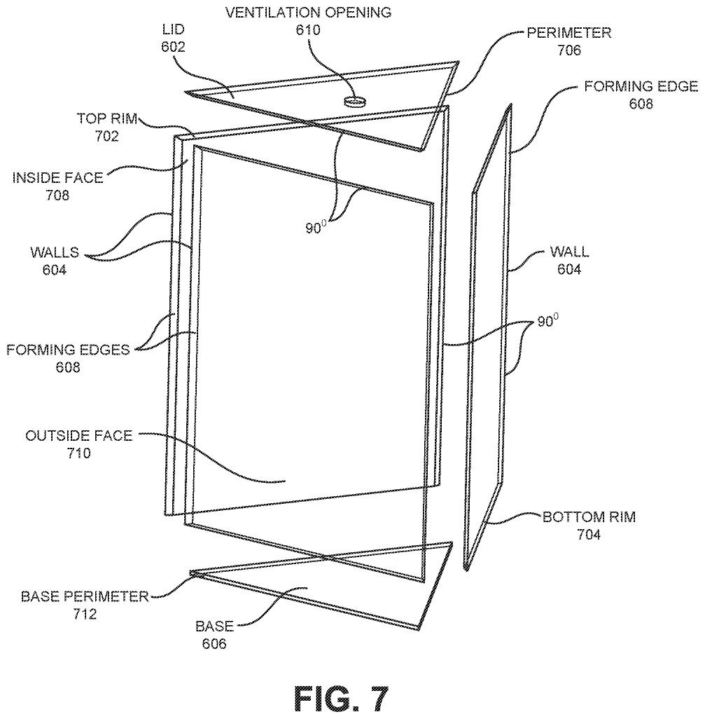

FIG. 7 is an exploded view of the enclosure 600 of FIG. 6 wherein the walls 604, the base 606, and the lid 602 are shown apart from one another, according to one embodiment. FIG. 7 comprises the lid 602, the plurality walls 604, the base 606, the plurality of forming edges 608, the ventilation opening 610, a top rim 702, a bottom rim 704, a perimeter 706, an inside face 708, an outside face 710, and/or a base perimeter 712. The top rim 702 may be mitered and/or formed at the top horizontal portion of the plurality of walls 604. The top rim 702 may be obliquely angled from the upper point 802 (not shown) to the lower point 804 (not shown) of the plurality of walls 604 of the enclosure 600 which may form a structure that facilitates secure placement of the lid 602.

The bottom rim 704 may be the bottom horizontal edges of the plurality of walls 604 which may be mitered and/or formed at an angle that forms a ninety-degree angle when placed adjacent to the base perimeter 712. The bottom rim 704 may comprise any angle. The bottom rim 604 may attach to the base 606 at the base perimeter 712 which may fortify the enclosure's 600 foundation. The bottom rim 604 may be formed and/or mitered at any angle. When connected to the base perimeter 712 of the base 606, the bottom rim 704 may be substantially outside of the base perimeter 712.

The perimeter 706 may be mitered and/or formed at the outermost edges of the lid 602. The perimeter 706 may be formed at any oblique angle and may align with the top rim 702 to form a ninety-degree angle. The perimeter 706 may provide a surface for attachment of optional lid spacers 902 (not shown) to regulate airflow and maintain environmental conditions within the enclosure 600. The inside face 708 may be the inner surface of each of the plurality of walls 604 of the enclosure 600 which May be oriented toward the interior of the enclosure 600. The outside face 710 may be the exterior surface of each of the plurality of walls 604 of the enclosure 600 which may be facing outward.

The base perimeter 712 may be the edges of the base 606 and may form an angle that creates a ninety-degree angle when adjacent to the bottom rim 704 of the plurality of walls 604 which may ensure a water-tight seal and/or a visually appealing finish. The base perimeter 712 may be formed on the base 606 at any angle. The base perimeter 712 of the base 606 may be connected to the walls 604 at an area adjacent to the bottom rim 704 of the walls 604. The base perimeter 712 of the base 606 may connect to the walls 604 at the inside face 708 portion of the bottom rim 704.

According to one embodiment, FIG. 7 discloses the enclosure 600 may comprise the bottom rim 704 that may be mitered and/or formed into the lower-vertical side of at least three walls 604 (the plurality of walls 604). The bottom rim 704 of at least three walls 604 may be connected to the base perimeter 712 of the base 606. The bottom rim 704 and the base perimeter form a ninety-degree angle when connected to each other.

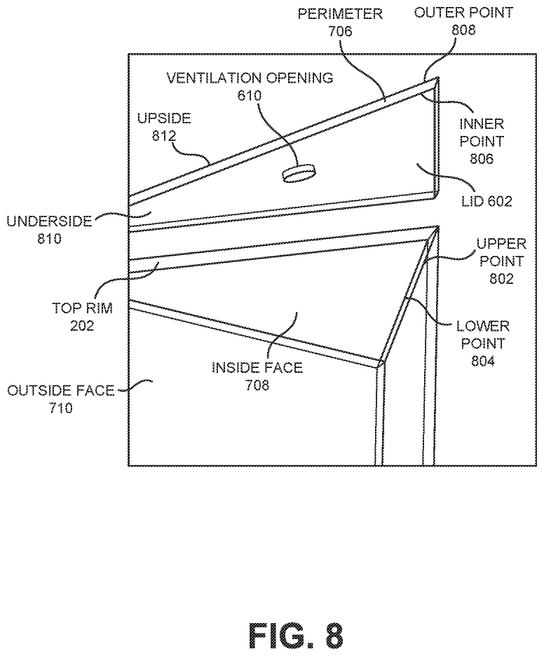

FIG. 8 is a schematic illustration of the enclosure 600 of FIGS. 6 & 7 wherein the lid 602 is removed from the enclosure 600, according to one embodiment. FIG. 8 comprises the ventilation opening 610, the top rim 702, the perimeter 706, the inside face 708, the outside face 710, an upper point 802, a lower point 804, an inner point 806, an outer point 808, an underside 810, and an upside 812. The upper point 802 may be positioned at the outermost edge of the top rim 702 of the enclosure 600 which may serve as a reference point for aligning the lid 602 during assembly. The upper point 802 may facilitate the placement of the lid 602 onto the enclosure 600. The lower point 804 may be located on the inner surface of the top rim 702 of the enclosure 600, obliquely oriented from the upper point 802.

The lower point 804 may serve as a counterpart to the upper point 802 which may form a precise angle that may aid in the alignment and/or attachment of the lid 602. The inner point 806 may be situated on the underside of the perimeter 706 of the lid 602. The inner point 806 may be adjacent to the lower point 804 of the top rim 702 when the lid 602 is placed on the top rim 702 of the plurality of walls 604. The inner point 806 may mark the innermost edge of the perimeter 706 of the lid 602 and may ensure a snug and secure fit between the lid 602 and the top rims 702 of the plurality of walls 604. The inner point's 806 position may correspond to the lower point 804 of the top rim 702 when the lid 602 is placed on the top rim 702 of the plurality of walls 604.

The outer point's 808 position may correspond to the upper point 802 when the lid 602 is placed on the top rim 702 of the plurality of walls 604. The outer point 808 may serve as a reference for aligning the lid 602 with the top rim 702 of the enclosure 600. By matching the outer point 808 with the upper point 802 of the top rim 702, users may easily position the lid 602 for attachment.

The underside 810 may be the lower surface of the lid 602 which may be facing inward when the lid 602 is placed on the enclosure 600. The underside 810 may provide support and stability to the lid 602 to ensure that it remains securely in place once attached to the enclosure 600. The underside 810 may also feature grooves and/or channels to accommodate additional components, including but not limited to spacers and/or sealing materials. The upside 812 may be the upper surface of the lid 602, facing upward and/or outward when the lid 602 is placed on the enclosure 600. The upside 812 may serve as a protective barrier, shielding the interior of the enclosure from external elements including but not limited to dust, debris, or contaminants. Furthermore, the upside 812 may feature additional elements including but not limited to ventilation openings and/or access points to facilitate airflow, feeding, or maintenance tasks within the enclosure.

According to one embodiment, FIG. 8 discloses the enclosure 600 which may comprise the top rim 702 of the at least three walls 604 (the plurality of walls 604). The top rim 702 may comprise the upper point 802 and/or the lower point 804. The upper point 802 may be adjacent to the outside face 710 of the at least three walls 604. The lower point 804 may be adjacent to the inside face 708 of the at least three walls 604. The upper point 802 and the lower point 804 of the top rim 702 may be configured to form an oblique angle relative to each other.

The perimeter 706 of the lid 602 may comprise the outer point 808 of the perimeter 706 and/or the inner point 806 of the perimeter 706. The outer point 808 may be at the upside 812 of the lid 602 and the inner point 806 may be at the underside 810 of the lid 602. The outer point 808 and the inner point 806 of the perimeter 706 may be configured to form an oblique angle relative to each other.

The upper point 802 and the lower point 804 of the top rim 702 may be positioned at a forty-five degree angle from one another. The outer point 808 and the inner point 806 of the perimeter 706 of the lid 602 may be positioned at a forty-five degree angle from one another. The top rim 702 of at least three walls 604 and the perimeter 706 of the lid 602 may form a ninety-degree angle when the lid 602 is placed on the top rim 702 of at least three walls 604. The outer point 808 and the upper point 802 may be adjacent to one another when the lid 602 is placed on the top rim 702 of at least three walls 604. The inner point 806 and the lower point 804 may be adjacent to one another when the lid 602 is placed on the top rim 702 of at least three walls 604.

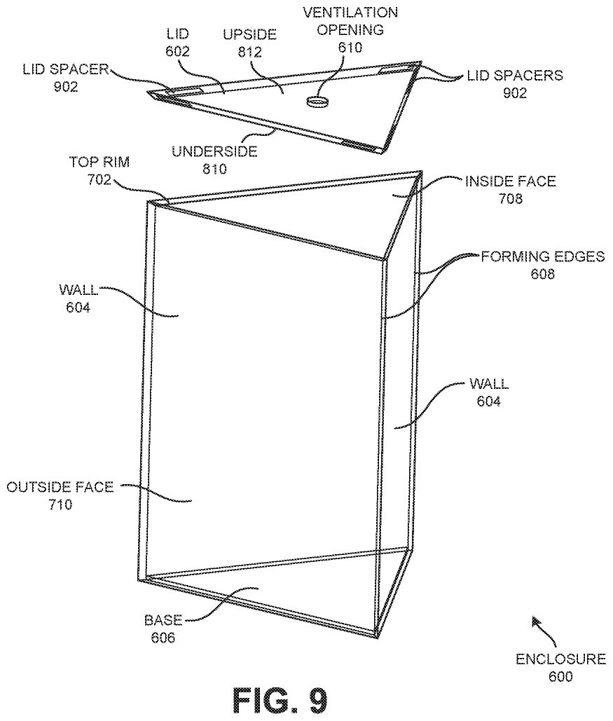

FIG. 9 is a schematic illustration of the enclosure 600 of FIGS. 6-8 wherein a plurality of lid spacers 902 are attached to the lid 602, according to one embodiment. FIG. 9 comprises the lid 602, the plurality walls 604, the base 606, the plurality of forming edges 608, the ventilation opening 610, the top rim 702, the bottom rim 704, the inside face 708, the outside face 710, the underside 810, the upside 812, and/or a lid spacer 902. The lid spacer 902 may be a removable component designed to facilitate humidity control and/or airflow within the enclosure 600. The lid spacer 902 may comprise a body with a shape that may complement the perimeter 706 of the lid 602 which may allow for easy attachment and/or removal. The lid spacer 902 may create a gap between the lid 602 and the top rim 702 of the plurality of walls 604. The lid spacer 902 may help regulate temperature and/or humidity levels to create an optimal environment for the habitat within the enclosure 600

According to one embodiment, FIG. 9 discloses the enclosure 600 which may comprise the lid spacer 902 that may be removably attached to the perimeter 706 of the lid 602. The lid spacer 902 may separate the lid 602 from at least three walls 604 (the plurality of walls 604) to facilitate humidity control and/or air movement into and/or out of the enclosure 600. The lid spacer 902 may comprise a body having a shape at least partially complementary to the perimeter 706 of the lid 602. The complementary shape of the lid spacer 902 may allow the lid spacer 902 to removably attach to the perimeter 706 of the lid 602.

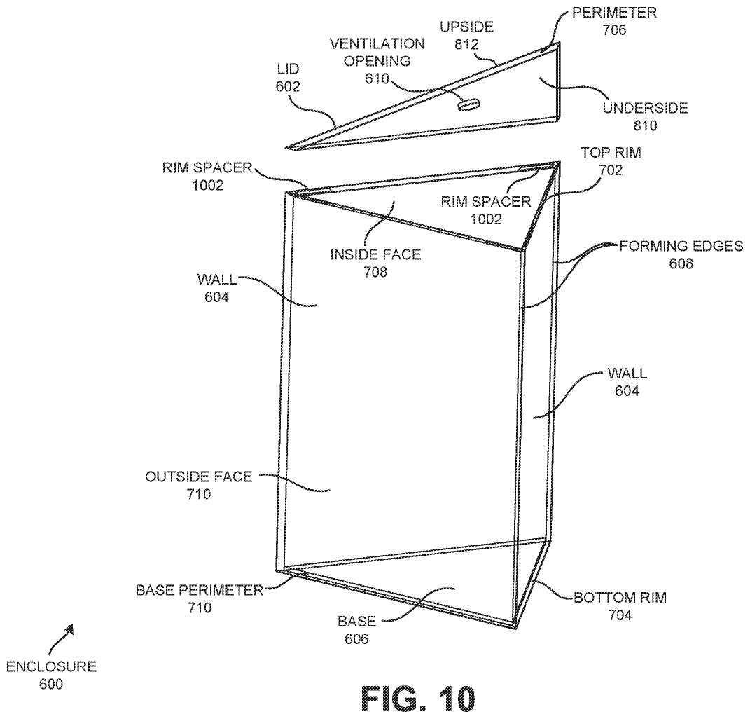

FIG. 10 is a schematic illustration of the enclosure 600 of FIGS. 6-9 wherein a plurality of rim spacers 1002 are attached to the top rim 702 of the enclosure 600, according to one embodiment. FIG. 10 comprises the lid 602, the plurality walls 604, the base 606, the plurality of forming edges 608, the ventilation opening 610, the top rim 702, the bottom rim 704, the inside face 708, the outside face 710, the underside 810, the upside 812, and/or a rim spacer 1002. The rim spacer 1002 may be removably attached to the enclosure 600 which may serve to separate the lid 602 from the top rims 702 of the plurality of walls 604 of the enclosure 600. The rim spacer 1002 may be designed to accommodate airflow into and/or out of the enclosure 600 to maintain consistent humidity and temperature levels. The rim spacer 1002 may feature a body with a shape that may complement the top rim 702 of the plurality walls 604 of the enclosure 600. The rim spacer 1002 may create a gap between the lid 602 and the plurality walls 604 to promote air circulation.

According to one embodiment, FIG. 10 discloses the enclosure 600 which may comprise the rim spacer 1002 that may be removably attached to the top rim 702 of the at least three walls 604 (the plurality of walls 604). The rim spacer 1002 may separate the lid 602 from at least one of the at least three walls 604 to facilitate humidity control and/or air movement into and/or out of the enclosure 600. The rim spacer 1002 may comprise a body having a shape at least partially complementary to the top rim 702 of the at least three walls 604. The complementary shape of the rim spacer 1002 may allow the rim spacer 1002 to removably attach to the top rim 702 of at least one of the at least three walls 604.

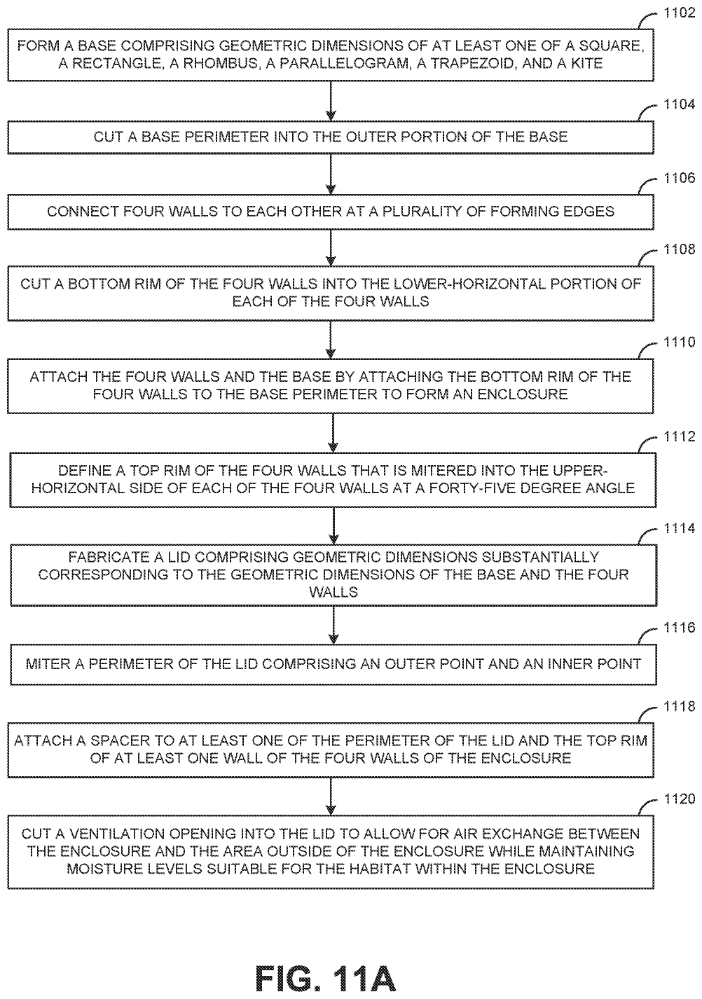

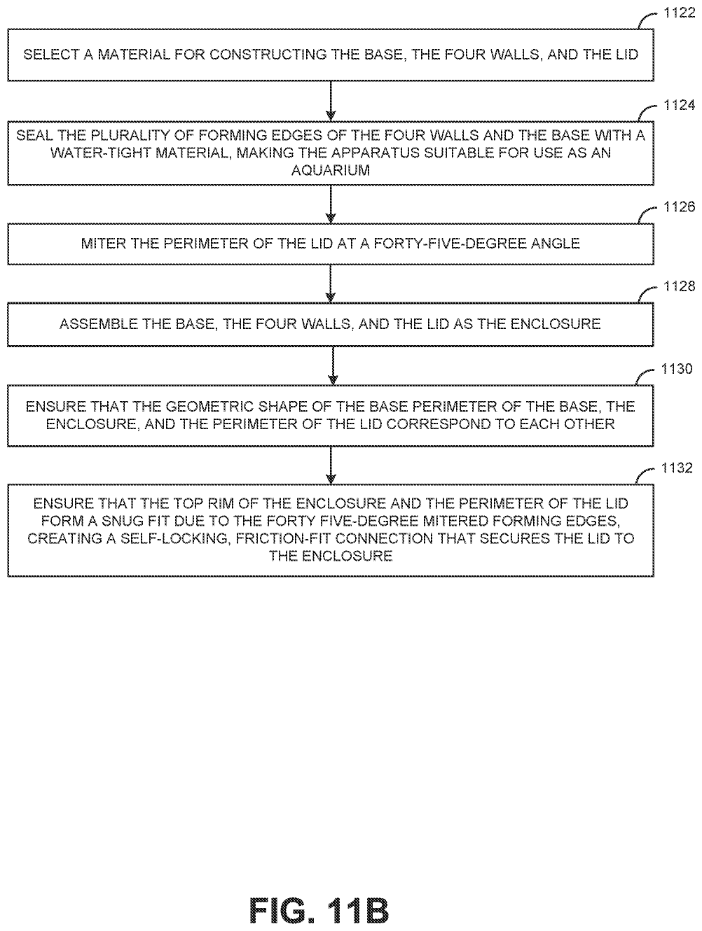

FIGS. 11A & 11B are process flow diagrams showing the steps of forming the various enclosure embodiments of FIGS. 1-10, according to one embodiment. In operation 1102, a base may be formed comprising geometric dimensions of at least one of a square, a rectangle, a rhombus, a parallelogram, a trapezoid, and/or a kite. In operation 1104, a base perimeter may be cut into the outer portion of the base.

In operation 1106, four walls may be connected to each other at a plurality of forming edges. In operation 1108, a bottom rim of the four walls may be cut into the lower-horizontal portion of each of the four walls. In operation 1110, the four walls and/or the base may be attached by attaching the bottom rim of the four walls to the base perimeter to form an enclosure. In operation 1112, a top rim of the four walls that is mitered into the upper-horizontal side of each of the four walls at a forty-five degree angle may be defined.

In operation 1114, a lid comprising geometric dimensions substantially corresponding to the geometric dimensions of the base and/or the four walls may be fabricated. In operation 1116, a perimeter of the lid comprising an outer point and/or an inner point may be mitered. In operation 1118, a spacer may be attached to at least one of the perimeter of the lid and/or the top rim of at least one wall of the four walls of the enclosure. In operation 1120, a ventilation opening may be cut into the lid to allow for air exchange between the enclosure and/or the area outside of the enclosure while maintaining moisture levels suitable for the habitat within the enclosure.

In operation 1122, a material for constructing the base, the four walls, and/or the lid may be selected. In operation 1124, the plurality of forming edges of the four walls and the base may be sealed with a water-tight material, making the apparatus suitable for use as an aquarium. In operation 1126, the perimeter of the lid may be mitered at a forty-five-degree angle. In operation 1128, the base, the four walls, and the lid may be assembled as the enclosure. In operation 1130, the geometric shape of the base perimeter of the base, the enclosure, and the perimeter of the lid may be ensured to correspond to each other. In operation 1132, the top rim of the enclosure and the perimeter of the lid may be ensured to form a snug fit due to the forty five-degree mitered forming edges, creating a self-locking, friction-fit connection that secures the lid to the enclosure.

Enclosures may be used by hobbyists and/or professionals alike to promote plant growth, promote animal growth, and/or add visual beauty and/or interior design to one's home, business, and/or office. Enclosures may consume a considerable amount of space which may outweigh the benefits of having said enclosure. By creating a large footprint, enclosures may be limited in where they can be placed which may create awkward placement within a room which may lead to reduced feng shui and/or room comfort. Enclosures may also comprise components that are susceptible to wear and tear including oxidation and rusting. As a result of this wear and tear, including oxidation and rusting, enclosure components may fail, thus costing users money and/or time repairing and/or replacing enclosure parts.

The embodiments of FIGS. 1-11B may remedy the issues involved with existing enclosures. The embodiments of FIGS. 1-11B may reduce the footprint created by enclosures which may allow owners/users more space within their home, business, school, and/or indoor setting. The embodiments of FIGS. 1-11B may enhance room feng shui and/or comfort by enabling users more placement options. The embodiments of FIGS. 1-11B may further relieve the need for metal and/or other oxidative and/or corrosive parts including hinges and/or clips. By reducing the need for these components, The embodiments of FIGS. 1-11B may thus reduce time spent repairing the enclosure which may create a more enjoyable and/or less tedious experience for the user. Furthermore, by reducing repair and part replacement, the embodiments of FIGS. 1-11B may reduce money spent on maintaining the enclosure, which may further create a positive user experience.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. An enclosure apparatus comprising:
a base in a substantially horizontal orientation, the base comprising a base perimeter that is located at the edges of the base,
wherein the base comprises geometric dimensions comprising at least three sides;
at least three walls comprising geometric dimensions substantially corresponding to the geometric dimensions of the base when the at least three walls are attached to one another,
wherein the at least three walls are attached at a plurality of forming edges, and
wherein the plurality of forming edges are mitered into the vertical sides of the at least three walls and form a total of at least one hundred and eighty degrees when the at least three walls are joined together;
a bottom rim located at the lower-vertical side of the at least three walls,
wherein the base perimeter of the base is connected to the at least three walls at an area adjacent to the bottom rim of the at least three walls,
a top rim of the at least three walls comprising an upper point and a lower point;
wherein the upper point is adjacent to an outside face of the at least three walls and the lower point is adjacent to an inside face of the at least three walls, and
wherein the upper point and the lower point of the top rim are configured to form an oblique angle relative to each other;
a lid comprising geometric dimensions substantially corresponding to the geometric dimensions of the base and the at least three walls;
a perimeter of the lid comprising an outer point of the perimeter and an inner point of the perimeter,
wherein the outer point is at an upside of the lid and the inner point is at an underside of the lid, and
wherein the outer point and the inner point of the perimeter are configured to form an oblique angle relative to each other.

2. The enclosure apparatus of claim 1, wherein the upper point and the lower point of the top rim are positioned at a forty-five degree angle from one another,
wherein the outer point and the inner point of the perimeter of the lid are positioned at a forty-five degree angle from one another,
wherein the top rim of the at least three walls and the perimeter of the lid form a ninety-degree angle when the lid is placed on the top rim of the at least three walls,
wherein the outer point and the upper point are adjacent to one another when the lid is placed on the top rim of the at least three walls,
and
wherein the inner point and the lower point are adjacent to one another when the lid is placed on the top rim of the at least three walls.

3. The enclosure apparatus of claim 1 further comprising:
a lid spacer removably attached to the perimeter of the lid,
wherein the lid spacer separates the lid from at least one wall of the at least three walls to facilitate humidity control and air movement into and out of the enclosure.

4. The enclosure apparatus of claim 1 further comprising:
a rim spacer removably attached to the top rim of at least one wall of the at least three walls,
wherein the rim spacer separates the lid from at least one wall of the at least three walls to facilitate humidity control and air movement into and out of the enclosure.

5. The enclosure apparatus of claim 3, wherein the lid spacer comprises a body having a shape at least partially complementary to the perimeter of the lid,
wherein the complementary shape of the lid spacer allows the lid spacer to removably attach to the perimeter of the lid.

6. The enclosure apparatus of claim 4, wherein the rim spacer comprises a body having a shape at least partially complementary to the top rim of the at least three walls,
wherein the complementary shape of the rim spacer allows the rim spacer to removably attach to the top rim of at least one wall of the at least three walls.

7. The enclosure apparatus of claim 1, wherein the at least three walls, the base, and the lid are made of a transparent material, allowing for clear visibility into the interior of the enclosure.

8. The enclosure apparatus of claim 7, wherein the transparent material is at least one of a glass, an acrylic, a polycarbonate, a tempered glass, a reinforced safety glass, a plexiglass, a laminated glass, a borosilicate glass, and a clear resin material.

9. The enclosure apparatus of claim 1, further comprising:
a ventilation opening cut into the lid allowing for air exchange from the enclosure into the exterior environment while maintaining the structural integrity and moisture levels suitable for the habitat within the enclosure.

10. The enclosure apparatus of claim 1, wherein the forming edges where the at least three walls meet are sealed with a water-tight material, making the enclosure suitable for use as an aquarium.

11. The enclosure apparatus of claim 10, wherein the water-tight material is at least one of a silicone sealant, an epoxy resin, a polyurethane sealant, a rubber gasket material, a marine-grade adhesive, a butyl rubber sealant, a TPE (thermoplastic elastomer) sealant, a polysulfide sealant, an acrylic sealant, and a PVC (polyvinyl chloride) sealant.

12. An apparatus comprising:
an enclosure comprising four walls and a base,
wherein the base comprises geometric dimensions of at least one of a square, a rectangle, a rhombus, a parallelogram, a trapezoid, and a kite,
wherein the four walls are connected to each other at a plurality of forming edges to form the substantially same geometric shape of the base, and
wherein the plurality of forming edges are mitered into the vertical sides of the four walls and form a shape comprising a total of at least three-hundred and sixty degrees when the four walls are joined together to form the enclosure;
a base perimeter located at the outer portion of the base;
a bottom rim of the four walls located at the lower-horizontal portion of each of the four walls,
wherein the bottom rim of the four walls are connected to the base perimeter of the base,
wherein the base perimeter of the base is connected to the four walls at an area adjacent to the bottom rim of the four walls,
wherein when the four walls and the base are connected, the bottom rim is exterior to the base perimeter, and
wherein when connected, the bottom rim and the base perimeter form a ninety-degree angle;
a top rim of the four walls that is mitered into the upper-horizontal side of each of the four walls at a forty-five degree angle,
wherein the top rim comprises an upper point and a lower point,
wherein the upper point of the rim is at an outside face of the four walls, and the lower point is at an inside face of the four walls, and
wherein the upper point and the lower point are positioned forty-five-degrees from one another;
a lid comprising geometric dimensions substantially corresponding to the geometric dimensions of the base and the four walls,
wherein the lid is placed on the enclosure to substantially seal the enclosure from the outside environment;
a perimeter of the lid comprising an outer point and an inner point,
wherein the perimeter of the lid is at the outermost portion of the lid,
wherein the outer point is positioned at an upside of the lid and the inner point is at an underside of the lid,
wherein the outer point and inner point are positioned forty-five-degrees from each other,
wherein when the lid is placed on the top rim of the four walls of the enclosure, the outer point and upper point are adjacent to one another, and the inner point and lower point are adjacent to one another,
and
wherein the top rim of the four walls and the perimeter of the lid form a ninety degree angle when the lid is placed on the top rim of the at least four walls;
a spacer removably attached to at least one of the perimeter of the lid and the top rim of at least one wall of the four walls of the enclosure,
wherein the spacer separates the lid from the enclosure and accommodates airflow into the enclosure to maintain consistent humidity and temperature,
wherein the spacer comprises a body having a shape at least partially complementary to at least one of the perimeter of the lid and the top rim of at least one wall of the four walls of the enclosure;
a ventilation opening cut into the lid to allow for air exchange between the enclosure and the area outside of the enclosure while maintaining moisture levels suitable for the habitat within the enclosure.

13. The apparatus of claim 12, wherein when the four walls are connected at the forming edges, the two corresponding adjacent forming edges create at least a ninety-degree angle when connected to each other.

14. The apparatus of claim 12, wherein the ventilation opening is circular and is positioned substantially at the center of the lid.

15. The apparatus of claim 12, wherein the four walls, the base, and the lid are made of at least one of a glass, an acrylic, a polycarbonate, a tempered glass, a reinforced safety glass, a plexiglass, laminated glass, a borosilicate glass, and a clear resin materials, allowing for visibility into the interior of the enclosure and through the enclosure.

16. The apparatus of claim 12, wherein the four walls and the base are sealed to each other with a water-tight material, making the apparatus suitable for use as an aquarium.

17. A method for assembling an apparatus comprising:
forming a base comprising geometric dimensions of at least one of a square, a rectangle, a rhombus, a parallelogram, a trapezoid, and a kite;
cutting a base perimeter into the outer portion of the base;
connecting four walls to each other at a plurality of forming edges,
wherein the plurality of forming edges are mitered at a forty-five-degree angle and form a ninety-degree angle when joined to one another,
cutting a bottom rim of the four walls into the lower-horizontal portion of each of the four walls, attaching the four walls and the base by attaching the bottom rim of the four walls to the base perimeter to form an enclosure,
wherein when the four walls are attached to the base, the bottom rim of the four walls is exterior to the base perimeter of the base,
wherein the four walls adopt geometric dimensions substantially corresponding to the geometric shape of the base when the four walls are joined together at the forming edges;
defining a top rim of the four walls that is mitered into the upper-horizontal side of each of the four walls at a forty-five degree angle,
wherein the top rim comprises an upper point and a lower point,
wherein the upper point of the rim is at an outside face of the four walls, and the lower point is at an inside face of the four walls,
and
wherein the upper point and the lower point are positioned forty-five-degrees from one another;
fabricating a lid comprising geometric dimensions substantially corresponding to the geometric dimensions of the base and the four walls;
mitering a perimeter of the lid comprising an outer point and an inner point,
wherein the outer point is positioned at an upside of the lid and the inner point is at an underside of the lid,
wherein the outer point and inner point are positioned forty-five-degrees from each other.

18. The method of claim 17 further comprising:
attaching a spacer to at least one of the perimeter of the lid and the top rim of at least one wall of the four walls of the enclosure,
wherein the spacer at least partially separates the lid from the enclosure and accommodates airflow into the enclosure to maintain consistent humidity and temperature, and
wherein the spacer comprises a body having a shape at least partially complementary to at least one of the perimeter of the lid and the top rim of at least one wall of the four walls of the enclosure.

19. The method of claim 18 further comprising:
cutting a ventilation opening into the lid to allow for air exchange between the enclosure and the area outside of the enclosure while maintaining moisture levels suitable for the habitat within the enclosure.

20. The method of claim 19 further comprising:
selecting a material for constructing the base, the four walls, and the lid,
wherein the material is at least one of a glass, an acrylic, a polycarbonate, a tempered glass, a reinforced safety glass, a plexiglass, a laminated glass, a borosilicate glass, and a clear resin materials; and,
sealing the plurality of forming edges of the four walls and the base with a water-tight material, making the apparatus suitable for use as an aquarium,
wherein the water-tight material is at least one of a silicone sealant, an epoxy resin, a polyurethane sealant, a rubber gasket material, a marine-grade adhesive, a butyl rubber sealant, a TPE (thermoplastic elastomer) sealant, a polysulfide sealant, an acrylic sealant, and a PVC (polyvinyl chloride) sealant;
mitering the perimeter of the lid at a forty-five-degree angle;
assembling the base, the four walls, and the lid as the enclosure;
ensuring that the geometric shape of the base perimeter of the base, the enclosure, and the perimeter of the lid correspond to each other; and,
ensuring that the top rim of the enclosure and the perimeter of the lid form a snug fit due to the forty-five-degree mitered forming edges, creating a self-locking, friction-fit connection that secures the lid to the enclosure.
